(19) United States
(12) Patent Application Publication
(10) Pub. No.: US 2024/0331084 A1
(43) Pub. Date: Oct. 3, 2024

(54) IMAGE PROCESSING WITH SINGLE INTERPOLATION OPERATION FOR DE-MOSAICING AND WARPING

(71) Applicant: QUALCOMM Incorporated, San Diego, CA (US)

(72) Inventors: Eran Scharam, Misgav (IL); David Berrebi, Netanya (IL); Oren Shirak, Atlit (IL)

(21) Appl. No.: 18/190,634

(22) Filed: Mar. 27, 2023

(51) Int. Cl. G06T 3/00; G06T 3/40; H04N 1/60; H04N 9/69; H04N 23/73; H04N 23/741; H04N 25/611

(52) U.S. Cl. CPC G06T 3/18; G06T 3/4015; H04N 1/6005; H04N 9/69; H04N 23/73; H04N 23/741; H04N 25/611

(57) ABSTRACT

This disclosure provides systems, methods, and devices for image signal processing that support high dynamic range (HDR) and other multi-frame image processing. In a first aspect, a method of image processing includes receiving first image data in a first format, the first image data comprising a first exposure of a scene; determining processed first image data by performing a single interpolation operation for de-mosaicing and warping the first image data, wherein the processed first image data is in a second format different from the first image data in the first format; and determining a corrected image frame based on the processed first image data and second image data comprising a second exposure of the scene. Other aspects and features are also claimed and described.

### TECHNICAL FIELD

Aspects of the present disclosure relate generally to image processing, and more particularly, to image warping. Some features may enable and provide improved image processing, including improved efficiency in image processing.

### INTRODUCTION

Image capture devices are devices that can capture one or more digital images, whether still images for photos or sequences of images for videos. Capture devices can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

The increasing amount of image data captured by the image capture device has some negative effects that accompany the increasing resolution obtained by the additional image data. Additional image data increases the amount of processing performed by the image capture device in determining image frames and videos from the image data, as well as in performing other operations related to the image data. For example, the image data may be processed through several processing blocks for enhancing the image before the image data is displayed to a user on a display or transmitted to a recipient in a message. Each of the processing blocks consumes additional power proportional to the amount of image data, or number of megapixels, in the image capture. The additional power consumption may shorten the operating time of an image capture device using battery power, such as a mobile phone.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In some aspects, a number of processing operations and/or processing blocks within an image capture device may be reduced by combining multiple operations into a warping operation. For example, an operation may be performed that combines warping with de-mosaicing from a first data format to a second format such as from Bayer format to red-green-blue (RGB) format. In some embodiments, the operation may combine warping with de-mosaicing and one or more additional operations such as lateral chromatic aberration correction (LCAC). The combined operation may be implemented in a Bayer Image Correction and Adjustment (ICA) (BICA) processing block. The combining of multiple operations reduces a number of interpolation operations in the processing of image data, which reduces power consumption and increases image quality (IQ) of resulting photographs or videos.

The reduced number of operations with BICA processing may be particularly beneficial when processing high dynamic range (HDR) images. HDR images are generated from multiple exposures of a scene, resulting in the capture of two, three, four, or more times the data of a non-HDR image. Improving the efficiency for processing image data thus has a several-fold benefit with HDR image processing and other multi-frame processing.

In one aspect of the disclosure, a method for image processing includes receiving first image data in a first format, the first image data comprising a first exposure of a scene; and determining processed first image data by performing a single interpolation operation for de-mosaicing and warping the first image data, wherein the processed first image data is in a second format different from the first image data in the first format.

In an additional aspect of the disclosure, an apparatus includes at least one processor and a memory coupled to the at least one processor. The at least one processor is configured to perform operations including receiving first image data in a first format, the first image data comprising a first exposure of a scene; and determining processed first image data by performing a single interpolation operation for de-mosaicing and warping the first image data, wherein the processed first image data is in a second format different from the first image data in the first format.

In an additional aspect of the disclosure, an apparatus includes means for receiving first image data in a first format, the first image data comprising a first exposure of a scene; and means for determining processed first image data by performing a single interpolation operation for de-mosaicing and warping the first image data, wherein the processed first image data is in a second format different from the first image data in the first format.

In an additional aspect of the disclosure, a non-transitory computer-readable medium stores instructions that, when executed by a processor, cause the processor to perform operations. The operations include receiving first image data in a first format, the first image data comprising a first exposure of a scene; and determining processed first image data by performing a single interpolation operation for de-mosaicing and warping the first image data, wherein the processed first image data is in a second format different from the first image data in the first format.

Methods of image processing described herein may be performed by an image capture device and/or performed on image data captured by one or more image capture devices. Image capture devices, devices that can capture one or more digital images, whether still image photos or sequences of images for videos, can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

The image processing techniques described herein may involve digital cameras having image sensors and processing circuitry (e.g., application specific integrated circuits (ASICs), digital signal processors (DSP), graphics processing unit (GPU), or central processing units (CPU)). An image signal processor (ISP) may include one or more of these processing circuits and configured to perform operations to obtain the image data for processing according to the image processing techniques described herein and/or involved in the image processing techniques described herein. The ISP may be configured to control the capture of image frames from one or more image sensors and determine one or more image frames from the one or more image sensors to generate a view of a scene in an output image frame. The output image frame may be part of a sequence of image frames forming a video sequence. The video sequence may include other image frames received from the image sensor or other images sensors.

In an example application, the image signal processor (ISP) may receive an instruction to capture a sequence of image frames in response to the loading of software, such as a camera application, to produce a preview display from the image capture device. The image signal processor may be configured to produce a single flow of output image frames, based on images frames received from one or more image sensors. The single flow of output image frames may include raw image data from an image sensor, binned image data from an image sensor, or corrected image data processed by one or more algorithms within the image signal processor. For example, an image frame obtained from an image sensor, which may have performed some processing on the data before output to the image signal processor, may be processed in the image signal processor by processing the image frame through an image post-processing engine (IPE) and/or other image processing circuitry for performing one or more of tone mapping, portrait lighting, contrast enhancement, gamma adjustment, etc. The output image frame from the ISP may be stored in memory and retrieved by an application processor executing the camera application, which may perform further processing on the output image frame to adjust an appearance of the output image frame and reproduce the output image frame on a display for view by the user.

After an output image frame representing the scene is determined by the image signal processor and/or determined by the application processor, such as through image processing techniques described in various embodiments herein, the output image frame may be displayed on a device display as a single still image and/or as part of a video sequence, saved to a storage device as a picture or a video sequence, transmitted over a network, and/or printed to an output medium. For example, the image signal processor (ISP) may be configured to obtain input frames of image data (e.g., pixel values) from the one or more image sensors, and in turn, produce corresponding output image frames (e.g., preview display frames, still-image captures, frames for video, frames for object tracking, etc.). In other examples, the image signal processor may output image frames to various output devices and/or camera modules for further processing, such as for 3A parameter synchronization (e.g., automatic focus (AF), automatic white balance (AWB), and automatic exposure control (AEC)), producing a video file via the output frames, configuring frames for display, configuring frames for storage, transmitting the frames through a network connection, etc. Generally, the image signal processor (ISP) may obtain incoming frames from one or more image sensors and produce and output a flow of output frames to various output destinations.

In some aspects, the output image frame may be produced by combining aspects of the image correction of this disclosure with other computational photography techniques such as high dynamic range (HDR) photography or multi-frame noise reduction (MFNR). With HDR photography, a first image frame and a second image frame are captured using different exposure times, different apertures, different lenses, and/or other characteristics that may result in improved dynamic range of a fused image when the two image frames are combined. In some aspects, the method may be performed for MFNR photography in which the first image frame and a second image frame are captured using the same or different exposure times and fused to generate a corrected first image frame with reduced noise compared to the captured first image frame.

In some aspects, a device may include an image signal processor or a processor (e.g., an application processor) including specific functionality for camera controls and/or processing, such as enabling or disabling the binning module or otherwise controlling aspects of the image correction. The methods and techniques described herein may be entirely performed by the image signal processor or a processor, or various operations may be split between the image signal processor and a processor, and in some aspects split across additional processors.

The device may include one, two, or more image sensors, such as a first image sensor. When multiple image sensors are present, the image sensors may be differently configured. For example, the first image sensor may have a larger field of view (FOV) than the second image sensor, or the first image sensor may have different sensitivity or different dynamic range than the second image sensor. In one example, the first image sensor may be a wide-angle image sensor, and the second image sensor may be a tele image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. Any of these or other configurations may be part of a lens cluster on a mobile device, such as where multiple image sensors and associated lenses are located in offset locations on a frontside or a backside of the mobile device. Additional image sensors may be included with larger, smaller, or same field of views. The image processing techniques described herein may be applied to image frames captured from any of the image sensors in a multi-sensor device.

In an additional aspect of the disclosure, a device configured for image processing and/or image capture is disclosed. The apparatus includes means for capturing image frames. The apparatus further includes one or more means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors) and time of flight detectors. The apparatus may further include one or more means for accumulating and/or focusing light rays into the one or more image sensors (including simple lenses, compound lenses, spherical lenses, and non-spherical lenses). These components may be controlled to capture the first and/or second image frames input to the image processing techniques described herein.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a processor to perform the steps of the method. In some embodiments, the processor may be part of a mobile device including a first network adaptor configured to transmit data, such as images or videos in a recording or as streaming data, over a first network connection of a plurality of network connections; and a processor coupled to the first network adaptor and the memory. The processor may cause the transmission of output image frames described herein over a wireless communications network such as a 5G NR communication network.

The foregoing has outlined, rather broadly, the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of an example device for performing image capture from one or more image sensors.

FIG. 2A is a block diagram illustrating an example data flow path for image data processing in an image capture device according to one or more embodiments of the disclosure.

FIG. 2B is a block diagram of example image processing using Bayer ICA processing blocks according to some embodiments of the disclosure.

FIG. 2C is a block diagram of example image processing using Bayer ICA processing blocks according to some embodiments of the disclosure.

FIG. 3 is a flow chart of an example method for processing image data to process image data with reduced interpolation operations in high dynamic range (HDR) photography according to some embodiments of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support image processing, including techniques for multi-frame image processing, such as high dynamic range (HDR) photography. The image processing may include processing with a Bayer ICA processing block that combines two or more operations (e.g., lateral chromatic aberration correction (LCAC), de-mosaicing, and/or warping) in a single interpolation operation.

Particular implementations of the subject matter described in this disclosure may be implemented to realize one or more of the following potential advantages or benefits. The BICA processing enables HDR processing in Bayer/RGB (linear domain), reduces the number of interpolation operations in processing image data, and reduces the number of conversions between RGB and YUV (down-sampled non-linear domain). These reduced interpolations and/or conversions decrease the loss of information from the image data. Performing HDR in the Bayer domain may allow processing in the full sensor resolution without downscaling to reduce bandwidth and reduce power consumption. These advantages increase the quality of images and/or videos in regular and low-light conditions with preservation of higher levels of detail and better color reproduction. Each of these benefits improves the user experience with an image capture device by providing higher image quality resulting in a more realistic representation of the scene.

An example device for capturing image frames using one or more image sensors, such as a smartphone, may include a configuration of one, two, three, four, or more cameras on a backside (e.g., a side opposite a primary user display) and/or a front side (e.g., a same side as a primary user display) of the device. The devices may include one or more image signal processors (ISPs), Computer Vision Processors (CVPs) (e.g., AI engines), or other suitable circuitry for processing images captured by the image sensors. The one or more image signal processors (ISP) may store output image frames in a memory and/or otherwise provide the output image frames to processing circuitry (such as through a bus). The processing circuitry may perform further processing, such as for encoding, storage, transmission, or other manipulation of the output image frames.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

In the description of embodiments herein, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Aspects of the present disclosure are applicable to any electronic device including, coupled to, or otherwise processing data from one, two, or more image sensors capable of capturing image frames (or “frames”). The terms “output image frame” and “corrected image frame” may refer to image frames that have been processed by any of the discussed techniques. Further, aspects of the present disclosure may be implemented in devices having or coupled to image sensors of the same or different capabilities and characteristics (such as resolution, shutter speed, sensor type, and so on). Further, aspects of the present disclosure may be implemented in devices for processing image frames, whether or not the device includes or is coupled to the image sensors, such as processing devices that may retrieve stored images for processing, including processing devices present in a cloud computing system.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU)) configured to perform the recited function through hardware, software, or a combination of hardware configured by software.

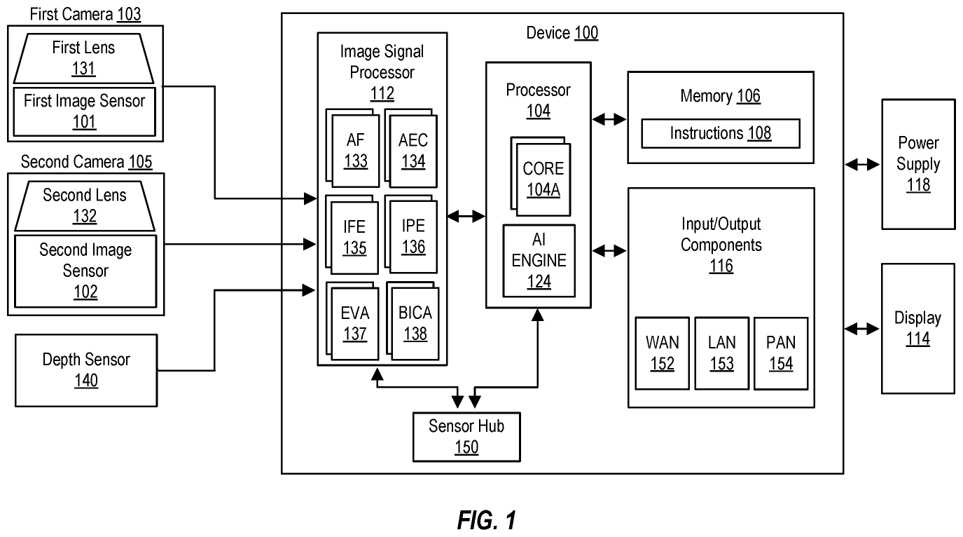

FIG. 1 shows a block diagram of an example device 100 for performing image capture from one or more image sensors. The device 100 may include, or otherwise be coupled to, an image signal processor 112 for processing image frames from one or more image sensors, such as a first image sensor 101, a second image sensor 102, and a depth sensor 140. In some implementations, the device 100 also includes or is coupled to a processor 104 and a memory 106 storing instructions 108. The device 100 may also include or be coupled to a display 114 and input/output (I/O) components 116. I/O components 116 may be used for interacting with a user, such as a touch screen interface and/or physical buttons.

I/O components 116 may also include network interfaces for communicating with other devices, including a wide area network (WAN) adaptor 152, a local area network (LAN) adaptor 153, and/or a personal area network (PAN) adaptor 154. An example WAN adaptor is a 4G LTE or a 5G NR wireless network adaptor. An example LAN adaptor 153 is an IEEE 802.11 WiFi wireless network adapter. An example PAN adaptor 154 is a Bluetooth wireless network adaptor. Each of the adaptors 152, 153, and/or 154 may be coupled to an antenna, including multiple antennas configured for primary and diversity reception and/or configured for receiving specific frequency bands.

The device 100 may further include or be coupled to a power supply 118 for the device 100, such as a battery or a component to couple the device 100 to an energy source. The device 100 may also include or be coupled to additional features or components that are not shown in FIG. 1. In one example, a wireless interface, which may include a number of transceivers and a baseband processor, may be coupled to or included in WAN adaptor 152 for a wireless communication device. In a further example, an analog front end (AFE) to convert analog image frame data to digital image frame data may be coupled between the image sensors 101 and 102 and the image signal processor 112.

The device may include or be coupled to a sensor hub 150 for interfacing with sensors to receive data regarding movement of the device 100, data regarding an environment around the device 100, and/or other non-camera sensor data. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and/or distance may be included in generated motion data. In some aspects, a gyroscope in an electronic image stabilization system (EIS) may be coupled to the sensor hub or coupled directly to the image signal processor 112. In another example, a non-camera sensor may be a global positioning system (GPS) receiver.

The image signal processor 112 may receive image data, such as used to form image frames. In one embodiment, a local bus connection couples the image signal processor 112 to image sensors 101 and 102 of a first camera 103 and second camera 105, respectively. In another embodiment, a wire interface couples the image signal processor 112 to an external image sensor. In a further embodiment, a wireless interface couples the image signal processor 112 to the image sensor 101, 102.

The first camera 103 may include the first image sensor 101 and a corresponding first lens 131. The second camera may include the second image sensor 102 and a corresponding second lens 132. Each of the lenses 131 and 132 may be controlled by an associated autofocus (AF) algorithm 133 executing in the ISP 112, which adjust the lenses 131 and 132 to focus on a particular focal plane at a certain scene depth from the image sensors 101 and 102. The AF algorithm 133 may be assisted by depth sensor 140.

The first image sensor 101 and the second image sensor 102 are configured to capture one or more image frames. Lenses 131 and 132 focus light at the image sensors 101 and 102, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging. The first lens 131 and second lens 132 may have different field of views to capture different representations of a scene. For example, the first lens 131 may be an ultra-wide (UW) lens and the second lens 132 may be a wide (W) lens. The multiple image sensors may include a combination of ultra-wide (high field-of-view (FOV)), wide, tele, and ultra-tele (low FOV) sensors.

That is, each image sensor may be configured through hardware configuration and/or software settings to obtain different, but overlapping, field of views. In one configuration, the image sensors are configured with different lenses with different magnification ratios that result in different fields of view. The sensors may be configured such that a UW sensor has a larger FOV than a W sensor, which has a larger FOV than a T sensor, which has a larger FOV than a UT sensor. For example, a sensor configured for wide FOV may capture fields of view in the range of 64-84 degrees, a sensor configured for ultra-side FOV may capture fields of view in the range of 100-140 degrees, a sensor configured for tele FOV may capture fields of view in the range of 10-30 degrees, and a sensor configured for ultra-tele FOV may capture fields of view in the range of 1-8 degrees.

The camera 103 may be a variable aperture (VA) camera in which the aperture can be controlled to a particular size. Example aperture sizes are f/2.0, f/2.8, f/3.2, f/8.0, etc. Larger aperture values correspond to smaller aperture sizes, and smaller aperture values correspond to larger aperture sizes. The camera 103 may have different characteristics based on the current aperture size, such as a different depth of focus (DOF) at different aperture sizes.

The image signal processor 112 processes image frames captured by the image sensors 101 and 102. While FIG. 1 illustrates the device 100 as including two image sensors 101 and 102 coupled to the image signal processor 112, any number (e.g., one, two, three, four, five, six, etc.) of image sensors may be coupled to the image signal processor 112. In some aspects, depth sensors such as depth sensor 140 may be coupled to the image signal processor 112, and output from the depth sensors are processed in a similar manner to that of image sensors 101 and 102. Example depth sensors include active sensors, including one or more of indirect Time of Flight (iToF), direct Time of Flight (dToF), light detection and ranging (Lidar), mmWave, radio detection and ranging (Radar), and/or hybrid depth sensors, such as structured light. In embodiments without a depth sensor 140, similar information regarding depth of objects or a depth map may be generated in a passive manner from the disparity between two image sensors (e.g., using depth-from-disparity or depth-from-stereo), phase detection auto-focus (PDAF) sensors, or the like. In addition, any number of additional image sensors or image signal processors may exist for the device 100.

In some embodiments, the image signal processor 112 may execute instructions from a memory, such as instructions 108 from the memory 106, instructions stored in a separate memory coupled to or included in the image signal processor 112, or instructions provided by the processor 104. In addition, or in the alternative, the image signal processor 112 may include specific hardware (such as one or more integrated circuits (ICs)) configured to perform one or more operations described in the present disclosure. For example, the image signal processor 112 may include one or more image front ends (IFEs) 135, one or more image post-processing engines 136 (IPEs), one or more auto exposure compensation (AEC) 134 engines, one or more engines for video analytics (EVAs) and/or one or more Bayer ICA (BICA) engines 138. The AF 133, AEC 134, IFE 135, IPE 136, EVA 137, and/or BICA 138 may each include application-specific circuitry, be embodied as software code executed by the ISP 112, and/or a combination of hardware in and software code executing on the ISP 112.

In some implementations, the memory 106 may include a non-transient or non-transitory computer readable medium storing computer-executable instructions 108 to perform all or a portion of one or more operations described in this disclosure. In some implementations, the instructions 108 include a camera application (or other suitable application) to be executed by the device 100 for generating images or videos. The instructions 108 may also include other applications or programs executed by the device 100, such as an operating system and specific applications other than for image or video generation. Execution of the camera application, such as by the processor 104, may cause the device 100 to generate images using the image sensors 101 and 102 and the image signal processor 112. The memory 106 may also be accessed by the image signal processor 112 to store processed frames or may be accessed by the processor 104 to obtain the processed frames. In some embodiments, the device 100 does not include the memory 106. For example, the device 100 may be a circuit including the image signal processor 112, and the memory may be outside the device 100. The device 100 may be coupled to an external memory and configured to access the memory for writing output frames for display or long-term storage. In some embodiments, the device 100 is a system-on-chip (SoC) that incorporates the image signal processor 112, the processor 104, the sensor hub 150, the memory 106, and input/output components 116 into a single package.

In some embodiments, at least one of the image signal processor 112 or the processor 104 executes instructions to perform various operations described herein, including high dynamic range (HDR) photography operations or other multi-frame photography or video operations. For example, execution of the instructions can instruct the image signal processor 112 to begin or end capturing an image frame or a sequence of image frames, in which the capture includes capturing multiple image frames and processing the multiple image frames as described in embodiments herein. In some embodiments, the processor 104 may include one or more general-purpose processor cores 104A capable of executing scripts or instructions of one or more software programs, such as instructions 108 stored within the memory 106. For example, the processor 104 may include one or more application processors configured to execute the camera application (or other suitable application for generating images or video) stored in the memory 106.

In executing the camera application, the processor 104 may be configured to instruct the image signal processor 112 to perform one or more operations with reference to the image sensors 101 or 102. For example, a camera application executing on processor 104 may receive a user command to begin a video preview display upon which a video comprising a sequence of image frames is captured and processed from one or more image sensors 101 or 102 through the image signal processor 112. Image processing to generate “output” or “corrected” image frames, such as according to techniques described herein, may be applied to one or more image frames in the sequence. Execution of instructions 108 outside of the camera application by the processor 104 may also cause the device 100 to perform any number of functions or operations. In some embodiments, the processor 104 may include ICs or other hardware (e.g., an artificial intelligence (AI) engine 124 or other co-processor) to offload certain tasks from the cores 104A. The AI engine 124 may be used to offload tasks related to, for example, face detection and/or object recognition. In some other embodiments, the device 100 does not include the processor 104, such as when all of the described functionality is configured in the image signal processor 112.

In some embodiments, the display 114 may include one or more suitable displays or screens allowing for user interaction and/or to present items to the user, such as a preview of the image frames being captured by the image sensors 101 and 102. In some embodiments, the display 114 is a touch-sensitive display. The I/O components 116 may be or include any suitable mechanism, interface, or device to receive input (such as commands) from the user and to provide output to the user through the display 114. For example, the I/O components 116 may include (but are not limited to) a graphical user interface (GUI), a keyboard, a mouse, a microphone, speakers, a squeezable bezel, one or more buttons (such as a power button), a slider, a switch, and so on.

While shown to be coupled to each other via the processor 104, components (such as the processor 104, the memory 106, the image signal processor 112, the display 114, and the I/O components 116) may be coupled to each another in other various arrangements, such as via one or more local buses, which are not shown for simplicity. While the image signal processor 112 is illustrated as separate from the processor 104, the image signal processor 112 may be a core of a processor 104 that is an application processor unit (APU), included in a system on chip (SoC), or otherwise included with the processor 104. While the device 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. As such, the present disclosure is not limited to a specific device or configuration of components, including the device 100.

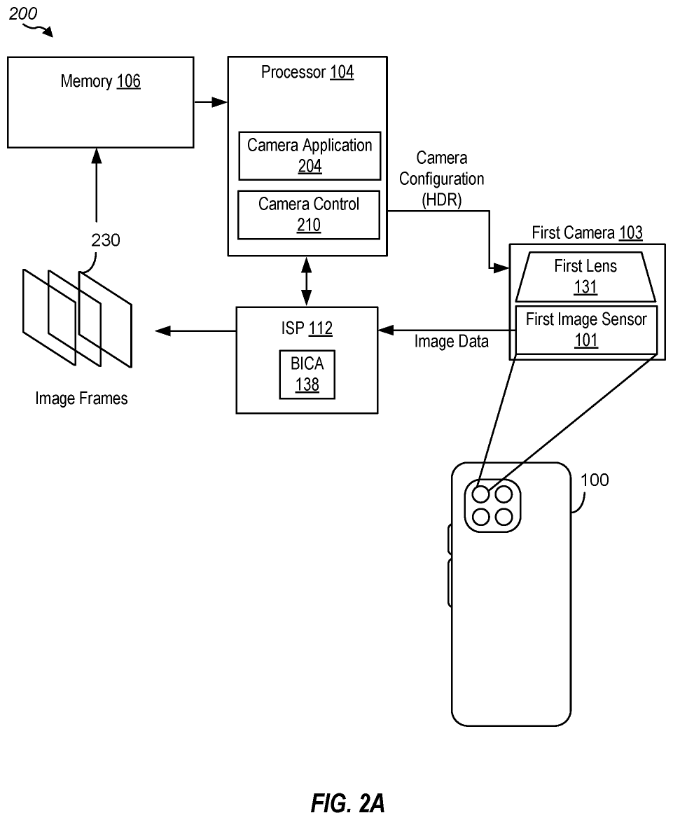

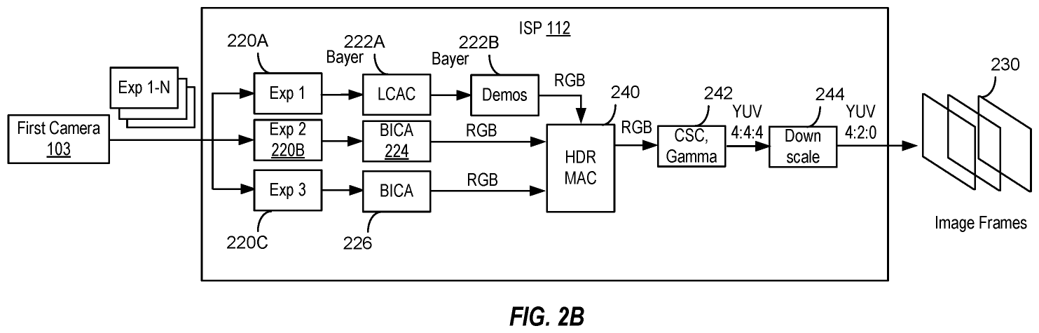

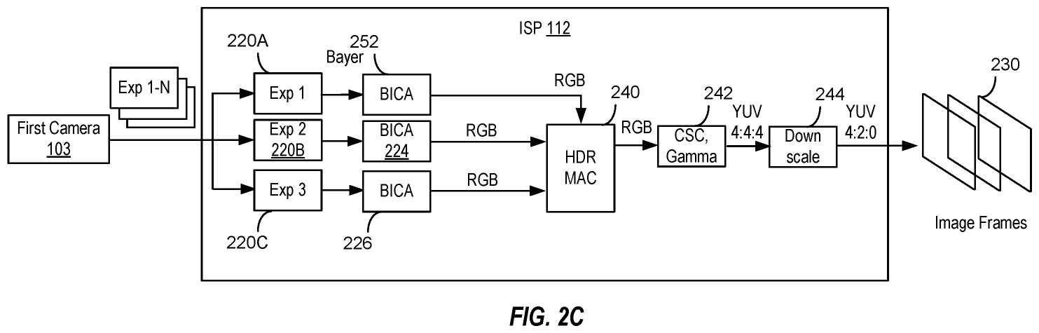

The exemplary image capture device of FIG. 1 may be operated to obtain improved images by processing image frames by combining operations to reduce a number of interpolation operations. One example method of operating one or more cameras, such as camera 103, is shown in FIG. 2A and described below.

FIG. 2A is a block diagram illustrating an example data flow path for image data processing in an image capture device according to one or more embodiments of the disclosure. A processor 104 of system 200 may communicate with image signal processor (ISP) 112 through a bi-directional bus and/or separate control and data lines. The processor 104 may control camera 103 through camera control 210, such as by configuring the camera 103 through a driver executing on the processor 104. The camera control 210 may be managed by a camera application 204 executing on the processor 104, which provides settings accessible to a user such that a user can specify individual camera settings or select a profile with corresponding camera settings. The camera control 210 communicates with the camera 103 to configure the camera 103 in accordance with commands received from the camera application 204, such as to active or deactivate high dynamic range (HDR) photography or other multi-frame capture operations. The camera control 210 may also control the ISP 112 by configuring an image pipeline to active, deactivate, and sequence one or more of the IFE 135, IPE 136, EVA 137, and/or BICA 138 in the ISP 112. The camera application 204 may be, for example, a photography application, a document scanning application, a messaging application, or other application that processes image data acquired from camera 103.

The camera configuration may include parameters that specify, for example, a frame rate, an image resolution, a readout duration, an exposure level, an aspect ratio, an aperture size, etc. The camera 103 may obtain image data based on the camera configuration. For example, the processor 104 may execute a camera application 204 to instruct camera 103, through camera control 210, to set a first camera configuration for the camera 103, to obtain first image data from the camera 103 operating in the first camera configuration, to instruct camera 103 to set a second camera configuration for the camera 103, and to obtain second image data from the camera 103 operating in the second camera configuration.

The image data received from camera 103 may be processed in one or more blocks of the ISP 112 to form image frames 230 that are stored in memory 106 and/or provided to the processor 104. The processor 104 may further process the image data to apply effects to the image frames 230. Effects may include Bokeh, lighting, and/or color casting. In some embodiments, functionality for effect application may be embedded in a different component, such as the ISP 112, a DSP, an ASIC, or other custom logic circuit for performing the additional image processing.

The ISP 112 with BICA 138 may be configured to include the BICA in an image processing pipeline to process image data received from a camera 103 (and/or additional cameras) to determine output image frames 230. An example pipeline configuration corresponding to a high dynamic range (HDR) image pipeline is shown in FIG. 2B, which may be activated when the camera application 204 is configured for HDR photography.

Dynamic range may be important to image quality when capturing a representation of a scene with a wide color gamut using an image capture device. Conventional image sensors have a limited dynamic range, which may be smaller than the dynamic range of human eyes. Dynamic range may refer to the light range between bright portions of an image and dark portions of an image. A conventional image sensor may increase an exposure time to improve detail in dark portions of an image at the expense of saturating bright portions of an image. Alternatively, a conventional image sensor may decrease an exposure time to improve detail in bright portions of an image at the expense of losing detail in dark portions of the image. Thus, image capture devices conventionally balance conflicting desires, preserving detail in bright portions or dark portions of an image, by adjusting exposure time. High dynamic range (HDR) photography improves photography using these conventional image sensors by combining multiple recorded representations of a scene from the image sensor.

FIG. 2B is a block diagram of example image processing using Bayer ICA processing blocks according to some embodiments of the disclosure. The ISP 112 configured for HDR photography as in FIG. 2B may receive image data from the first camera 103, including a first exposure 220A, a second exposure 220B, and a third exposure 220C. The three exposures may correspond to short, medium and long exposures of different exposure durations of t₁, t₂, and t₃, with t₁<t₂<t₃.

The RAW image data from the camera 103 may be in a first format, such as Bayer data. Each of the exposures 220A-C may be processed through separate blocks. The first exposure 220A may be processed through a LCAC block 222A and a demosaic block 222B to obtain RGB data. The second exposure 220B may be processed through a BICA block 224; and the third exposure 220C may be processed through a BICA block 226. The BICA blocks 224 and 226 perform multiple operations on the Bayer image data of the second and third exposures 220B-C to obtain RGB data. The BICA blocks 224 and 226 may perform multiple operations with only a single interpolation operation, including one or more of warping, de-mosaicing, and LCAC. In some embodiments, the image pipeline shown in FIG. 2B may include sharing a single BICA block to perform the operations of BICA 224 and BICA 226.

In some embodiments, the first exposure 220A may be processed with a BICA block in addition to or in alternative to processing in LCAC 222A and demosaic 222B, such that the three exposures 220A-C are similarly processed. An example embodiment with processing for all exposures through a BICA block is shown in FIG. 2C, which includes a BICA block 252 for processing the first exposure 220A.

The processed RGB data from exposures 220A-C may be merged in HDR MAC 240, which outputs RGB data with a higher dynamic range than any of the RGB data. In some embodiments, additional multi-frame processing blocks may be combined with HDR MAC 240 or replace HDR MAC 240. The output of the HDR MAC 240, or other multi-frame processing block may be processed through gamma adjustment and color space transform block 242 to obtain YUV 4:4:4 formatted image data. The YUV 4:4:4 data may be processed in downscaling block 244 to obtain YUV 4:2:2 formatted image data, which may be separated into separate image frames for output as image frames 230.

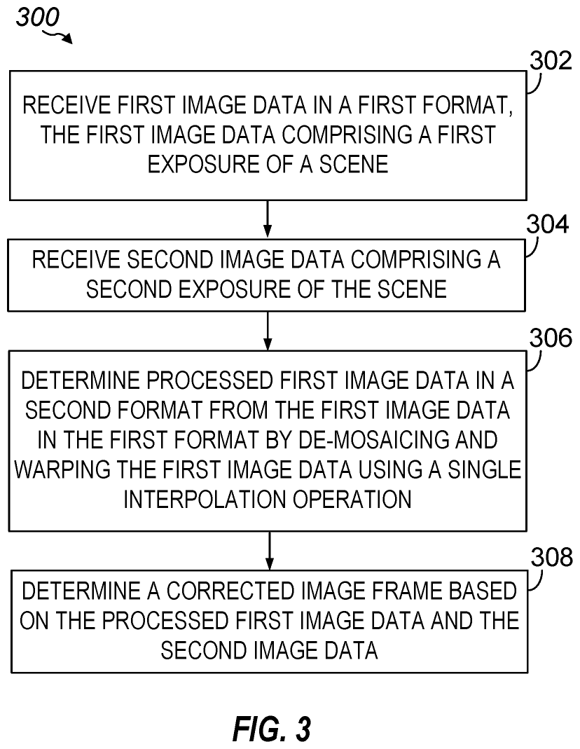

The system 200 of FIG. 2A configured in, for example, the image processing pipeline of FIG. 2B may be configured to perform the operations described with reference to FIG. 3 to determine output image frames 230. FIG. 3 is a flow chart of an example method for processing image data with reduced interpolation operations in high dynamic range (HDR) photography according to some embodiments of the disclosure. The capturing in FIG. 3 may obtain an improved digital representation of a scene, which results in a photograph or video with higher image quality (IQ).

A method 300 includes, at block 302, receiving first image data in a first format comprising a first exposure 220A representing a scene. At block 304, second image data is received comprising a second exposure 220B representing the scene. The first image data may be received at ISP 112 and stored in memory, such as a buffer. In some embodiments, the capture of image data may be initiated by a camera application 204 executing on the processor 104, which causes camera control 210 to activate capture of image data by the camera 103 and cause the image data to be supplied to the ISP 112.

At block 306, processed first image data in a second format is determined from the first image data in the first format. The processing of block 304 may include de-mosaicing and warping the first image data using a single interpolation operation in a BICA block 226. The de-mosaicing operation may convert the image data from the first format to the second format, such as from Bayer to RGB, GBR to RGB, or GBR to GBR. The warping operation may align pixels of the first exposure to corresponding pixels of the second exposure, such that merging of the processed first image data and the second image data matches corresponding portions of the scene between the two image data. The warping may reduce blurriness and/or ghosting resulting from combination of two image unaligned image data caused by global and/or local motion in the scene. The processing of block 304 may also include applying a lateral chromatic aberration correction (LCAC).

The processing at block 306 through BICA block 224 or 226 may involve only a single interpolation operation. In contrast to processing through BICA blocks 224 or 226, the processing through LCAC 222A and demosaic 222B may involve an interpolation at each of the LCAC 222A and demosaic 222B. Processing through BICA blocks thus enables HDR processing with less data lost from interpolation operations. Further, the HDR or other multi-frame processing is performed prior to quantization in gamma adjustment block 242.

At block 308, a corrected image frame 230 is determined by combining the processed first image data and the second image data. For example, a HDR merging operation may be performed to combine the processing first image data and the second image data in HDR MAC 240. The second image data may also be processed prior to the determining of the corrected image frame. For example, the second image data may be processed through BICA block 224, with the output of BICA blocks 224 and 226 combined in block 308.

The HDR merging may combine several images frames with different exposures by selecting the best pixels from each exposure. For example, in areas where pixels are over exposed in the long exposure, the pixels of the corrected image frame in these areas are taken from the shorter exposures, and in other areas where pixels are under exposed, the pixels of the corrected image frame in these areas would be taken from the longer exposures. The corrected image frame is thus an image with a wider dynamic range than any of the single exposures.

The process of method 300 may be repeated to form multiple image frames 230 and stored in memory 106. The stored image frames may be read by the processor 104 and used to form a preview display on a display of the device 100 and/or processed to form a photograph for storage in memory 106 and/or transmission to another device.

In one or more aspects, techniques for supporting image processing may include additional aspects, such as any single aspect or any combination of aspects described below or in connection with one or more other processes or devices described elsewhere herein. In a first aspect, supporting image processing may include an apparatus configured to perform operations including receiving first image data in a first format, the first image data comprising a first exposure of a scene; and determining processed first image data by performing a single interpolation operation for de-mosaicing and warping the first image data, wherein the processed first image data is in a second format different from the first image data in the first format.

Additionally, the apparatus may perform or operate according to one or more aspects as described below. In some implementations, the apparatus includes a wireless device, such as a UE. In some implementations, the apparatus includes a remote server, such as a cloud-based computing solution, which receives image data for processing to determine output image frames. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, determining the processed first image data further comprises applying lateral chromatic aberration correction (LCAC) during the single interpolation operation

In a third aspect, in combination with one or more of the first aspect or the second aspect, the apparatus is further configured to perform operations including receiving second image data comprising a second exposure of the scene; and determining a corrected image frame based on the processed first image data and the second image data.

In a fourth aspect, in combination with one or more of the first aspect through the third aspect, the first format is Bayer format and the second format is RGB format.

In a fifth aspect, in combination with one or more of the first aspect through the fourth aspect, determining the corrected image frame is performed using the processed first image data before converting the processed first image data to a third format, wherein the third format is YUV format.

In a sixth aspect, in combination with one or more of the first aspect through the fifth aspect, determining the corrected image frame comprises determining a high dynamic range (HDR) image frame with higher dynamic range than either the first image data or the second image data.

In a seventh aspect, in combination with one or more of the first aspect through the sixth aspect, the apparatus is further configured to perform operations including receiving third image data comprising a third exposure of the scene; and determining processed third image data by de-mosaicing and warping the third image data, wherein determining the corrected image frame is further based on the processed third image data.

In an eighth aspect, in combination with one or more of the first aspect through the seventh aspect, the apparatus is further configured to perform operations including applying gamma adjustment to the corrected image frame; and downscaling the corrected image frame after applying the gamma adjustment to the corrected image frame.

In a ninth aspect, in combination with one or more of the first aspect through the eighth aspect, the apparatus is further configured to perform operations including outputting the corrected image frame to a display.

In a tenth aspect, in combination with one or more of the first aspect through the ninth aspect, determining the corrected image frame comprises determining a motion compensated temporally filtered (MCTF) image frame.

In an eleventh aspect, in combination with one or more of the first aspect through the tenth aspect, the apparatus includes an image sensor.

In a twelfth aspect, in combination with one or more of the first aspect through the eleventh aspect, the apparatus is further configured to perform operations including receiving first image data from the image sensor in a first format, the first image data comprising a first exposure of a scene; receiving second image data in the first format, the second image data comprising a second exposure of the scene; receiving third image data in the first format, the third image data comprising a third exposure of the scene; determining processed first image data in a second format from the first image data in the first format by de-mosaicing and warping the first image data with a single interpolation operation; and determining a corrected image frame based on the processed first image data, the second image data, and/or the third image data, wherein determining the corrected image frame comprises determining a high dynamic range (HDR) image frame with higher dynamic range than either the first image data or the second image data.

In a thirteenth aspect, in combination with one or more of the first aspect through the twelfth aspect, the apparatus is further configured to perform operations including determining processed second image data in the second format from the second image data in the first format by de-mosaicing and warping the second image data with a single interpolation operation, wherein determining the corrected image frame based on the second image data comprises determining the corrected image frame based on the processed second image data.

In a fourteenth aspect, in combination with one or more of the first aspect through the thirteenth aspect, determining the processed first image data further comprises applying lateral chromatic aberration correction (LCAC) during the single interpolation operation and determining the processed second image data further comprises applying lateral chromatic aberration correction (LCAC) during the single interpolation operation.

In a fifteenth aspect, in combination with one or more of the first aspect through the fourteenth aspect, warping the first image data comprises aligning a first representation of the scene in the first image data with a second representation of the scene in the second image data.

In a sixteenth aspect, in combination with one or more of the first aspect through the fifteenth aspect, the apparatus includes a display, wherein the apparatus if configured to perform further operations including outputting the corrected image frame to the display.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-3 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIGS. 1, 2A-B, or 3 may be combined with one or more blocks (or operations) described with reference to another of the figures. For example, one or more blocks (or operations) of FIG. 2B may be combined with one or more blocks (or operations) of FIG. 3. As another example, one or more blocks associated with FIG. 2A may be combined with one or more blocks (or operations) associated with FIG. 3.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method, comprising:
receiving first image data in a first format, the first image data comprising a first exposure of a scene; and
determining processed first image data by performing a single interpolation operation for de-mosaicing and warping the first image data, wherein the processed first image data is in a second format different from the first image data in the first format.

2. The method of claim 1, wherein determining the processed first image data further comprises applying lateral chromatic aberration correction (LCAC) during the single interpolation operation.

3. The method of claim 1, further comprising:
receiving second image data comprising a second exposure of the scene; and
determining a corrected image frame based on the processed first image data and the second image data.

4. The method of claim 3, wherein the first format is Bayer format and the second format is RGB format.

5. The method of claim 4, wherein determining the corrected image frame is performed using the processed first image data before converting the processed first image data to a third format, wherein the third format is YUV format.

6. The method of claim 3, wherein determining the corrected image frame comprises determining a high dynamic range (HDR) image frame with higher dynamic range than either the first image data or the second image data.

7. The method of claim 6, further comprising:
receiving third image data comprising a third exposure of the scene; and
determining processed third image data by de-mosaicing and warping the third image data,
wherein determining the corrected image frame is further based on the processed third image data.

8. The method of claim 6, further comprising:
applying gamma adjustment to the corrected image frame; and
downscaling the corrected image frame after applying the gamma adjustment to the corrected image frame.

9. The method of claim 3, further comprising outputting the corrected image frame to a display.

10. The method of claim 3, wherein determining the corrected image frame comprises determining a motion compensated temporally filtered (MCTF) image frame.

11. An apparatus, comprising:
a memory storing processor-readable code; and
at least one processor coupled to the memory, the at least one processor configured to execute the processor-readable code to cause the at least one processor to perform operations including:
receiving first image data in a first format, the first image data comprising a first exposure of a scene; and
determining processed first image data by performing a single interpolation operation for de-mosaicing and warping the first image data, wherein the processed first image data is in a second format different from the first image data in the first format.

12. The apparatus of claim 11, wherein determining the processed first image data further comprises applying lateral chromatic aberration correction (LCAC) during the single interpolation operation.

13. The apparatus of claim 11, wherein the at least one processor is configured to execute the processor-readable code to cause the at least one processor to perform further operations including:
receiving second image data comprising a second exposure of the scene; and
determining a corrected image frame based on the processed first image data and the second image data.

14. The apparatus of claim 13, wherein the first format is Bayer format and the second format is RGB format.

15. The apparatus of claim 14, wherein determining the corrected image frame is performed using the processed first image data before converting the processed first image data to a third format, wherein the third format is YUV format.

16. The apparatus of claim 13, wherein determining the corrected image frame comprises determining a high dynamic range (HDR) image frame with higher dynamic range than either the first image data or the second image data.

17. The apparatus of claim 16, further comprising:
receiving third image data comprising a third exposure of the scene; and
determining processed third image data by de-mosaicing and warping the third image data,
wherein determining the corrected image frame is further based on the processed third image data.

18. The apparatus of claim 16, further comprising:
applying gamma adjustment to the corrected image frame; and
downscaling the corrected image frame after applying the gamma adjustment to the corrected image frame.

19. The apparatus of claim 18, wherein the at least one processor is configured to execute the processor-readable code to cause the at least one processor to perform further operations including outputting the corrected image frame to a display.

20. The apparatus of claim 13, wherein determining the corrected image frame comprises determining a motion compensated temporally filtered (MCTF) image frame.

21. A non-transitory computer-readable medium storing instructions that, when executed by a processor, cause the processor to perform operations comprising:
receiving first image data in a first format, the first image data comprising a first exposure of a scene; and
determining processed first image data by performing a single interpolation operation for de-mosaicing and warping the first image data, wherein the processed first image data is in a second format different from the first image data in the first format.

22. The non-transitory, computer-readable medium of claim 21, wherein determining the processed first image data further comprises applying lateral chromatic aberration correction (LCAC) during the single interpolation operation.

23. The non-transitory, computer-readable medium of claim 21, wherein the instructions cause the processor to perform operations further comprising:
receiving second image data comprising a second exposure of the scene; and
determining a corrected image frame based on the processed first image data and the second image data.

24. The non-transitory, computer-readable medium of claim 23, wherein determining the corrected image frame comprises determining a high dynamic range (HDR) image frame with higher dynamic range than either the first image data or the second image data.

25. The non-transitory, computer-readable medium of claim 24, wherein determining the processed first image data further comprises applying lateral chromatic aberration correction (LCAC) during the single interpolation operation.

26. An image capture device, comprising:
an image sensor;
a memory storing processor-readable code; and
at least one processor coupled to the memory and to the image sensor, the at least one processor configured to execute the processor-readable code to cause the at least one processor to perform operations comprising:
receiving first image data from the image sensor in a first format, the first image data comprising a first exposure of a scene;
receiving second image data in the first format, the second image data comprising a second exposure of the scene;
receiving third image data in the first format, the third image data comprising a third exposure of the scene;
determining processed first image data in a second format from the first image data in the first format by de-mosaicing and warping the first image data with a single interpolation operation; and
determining a corrected image frame based on the processed first image data, the second image data, and the third image data, wherein determining the corrected image frame comprises determining a high dynamic range (HDR) image frame with higher dynamic range than either the first image data or the second image data.

27. The image capture device of claim 26, further comprising:
determining processed second image data in the second format from the second image data in the first format by de-mosaicing and warping the second image data with a single interpolation operation,
wherein determining the corrected image frame based on the second image data comprises determining the corrected image frame based on the processed second image data.

28. The image capture device of claim 27, wherein determining the processed first image data further comprises applying lateral chromatic aberration correction (LCAC) during the single interpolation operation and determining the processed second image data further comprises applying lateral chromatic aberration correction (LCAC) during the single interpolation operation.

29. The image capture device of claim 28, wherein warping the first image data comprises aligning a first representation of the scene in the first image data with a second representation of the scene in the second image data.

30. The image capture device of claim 28, further comprising:
a display,
wherein the at least one processor is configured to execute the processor-readable code to cause the at least one processor to perform further operations including outputting the corrected image frame to the display.
